(19) United States
(12) Patent Application Publication
(10) Pub. No.: US 2020/0304752 A1
(43) Pub. Date: Sep. 24, 2020

(54) METHOD AND APPARATUS FOR ENHANCED VIDEO DISPLAY

(71) Applicant: GM GLOBAL TECHNOLOGY OPERATIONS LLC, Detroit, MI (US)

(72) Inventors: Sai Vishnu Aluru, Commerce, MI (US); Mohannad Murad, Troy, MI (US); James A. Carpenter, Rochester Hills, MI (US); Joseph G. Machak, Oakland Township, MI (US)

(73) Assignee: GM GLOBAL TECHNOLOGY OPERATIONS LLC, Detroit, MI (US)

(21) Appl. No.: 16/359,496

(22) Filed: Mar. 20, 2019

(51) Int. Cl. H04N 7/01; H04N 5/235; H04N 7/18

(52) U.S. Cl. CPC H04N 7/0117; B60R 1/00; H04N 7/183; H04N 5/2351

(57) ABSTRACT

Methods and apparatus are provided for real time video upscaling in a vehicle display system. The apparatus includes a camera for capturing an image having a first resolution, a display operative at a second resolution, a sensor for detecting a condition, and a processor for selecting a scaling algorithm in response to the first resolution, the second resolution and the condition, the processor further operative to scale the image from the first resolution to the second resolution to generate a rescaled image and for coupling the rescaled image to the display.

### INTRODUCTION

The technical field generally relates to automotive electronics and more particularly relates to an apparatus and method for real time video upscaling in a vehicle to apply different video upscaling algorithms in response to video content and environmental conditions to improve human perception of time video.

Automotive camera systems are becoming more and more ubiquitous and, subsequently, relied upon by drivers. Automotive cameras may provide rear views from bumper height in order to provide views of areas which are obstructed from a mirror's line of sight. Likewise cameras can provide front views, side views, and with current image processing techniques, these views can be stitched together to provide top down views from about the vehicle, or any combination of views.

In order to increase the number of cameras in an automotive camera system without significantly increasing costs or increasing system complexity, lower resolution cameras are often used. These lower resolution cameras often do not match the resolution of in vehicle displays and therefore the video resolution must be upscaled for display in the vehicle. Accordingly, it is desirable to upscale the video in a manner that provides the highest quality video for display to the vehicle occupants. Furthermore, other desirable features and characteristics of the present invention will become apparent from the subsequent detailed description and the appended claims, taken in conjunction with the accompanying drawings and the foregoing technical field and background.

### SUMMARY

Disclosed herein are vehicle camera and display methods and systems and related control logic for provisioning vehicle sensing and control systems, methods for making and methods for operating such systems, and motor vehicles equipped with onboard sensor and control systems. By way of example, and not limitation, there are presented various embodiments of enhanced video processing and display methods and systems working in concert with these systems disclosed herein.

In accordance with an aspect of the present invention a video system having a camera for capturing an image having a first resolution, a display operative at a second resolution, a luminance meter for measuring a luminance value, a video controller for determining a third resolution in response to a user input and for generating a user interface at the second resolution in response to the user input and an upscaled image, a processor for selecting an upscaling algorithm in response to the first resolution, the third resolution and the luminance value, the processor further operative to upscale the image from the first resolution to the third resolution to generate the upscaled image and for coupling the upscaled image to the video controller; and

In accordance with another aspect of the present invention a display for receiving the user interface from the video controller and for displaying the user interface.

In accordance with another aspect of the present invention wherein the luminance value is further determined in response to a camera frame rate.

In accordance with another aspect of the present invention wherein the sensor is a luminance meter.

In accordance with another aspect of the present invention wherein the display is a touch sensitive display and wherein the display is further operative to receive the user input.

In accordance with another aspect of the present invention an apparatus having a camera for capturing an image having a first resolution, a display operative at a second resolution, a sensor for detecting a condition, and a processor for selecting a scaling algorithm in response to the first resolution, the second resolution and the condition, the processor further operative to scale the image from the first resolution to the second resolution to generate a rescaled image and for coupling the rescaled image to the display.

In accordance with another aspect of the present invention wherein the condition is a luminance level.

In accordance with another aspect of the present invention wherein the condition is a camera frame rate.

In accordance with another aspect of the present invention wherein the condition is a contrast of the image.

In accordance with another aspect of the present invention wherein the sensor is a luminance meter.

In accordance with another aspect of the present invention wherein the second resolution is higher than the first resolution.

In accordance with another aspect of the present invention wherein the second resolution is 1920 by 1080 pixels and the first resolution is 1280 by 960 pixels.

In accordance with another aspect of the present invention wherein the first resolution is 1024 by 768 pixels.

In accordance with another aspect of the present invention a method for receiving an image having a first resolution, detecting a first condition in response to receiving the image, selecting an upscaling algorithm in response to the first resolution and the first condition, upscaling the image according to the upscaling algorithm to generate an upscaled image, and displaying the upscaled image.

In accordance with another aspect of the present invention wherein the first resolution is lower than the second resolution.

In accordance with another aspect of the present invention wherein the second resolution is 1920 by 1080 pixels and the first resolution is 1280 by 960 pixels.

In accordance with another aspect of the present invention wherein the first resolution is 1024 by 768 pixels.

In accordance with another aspect of the present invention wherein the condition is a luminance level.

In accordance with another aspect of the present invention wherein the condition is a camera frame rate.

In accordance with another aspect of the present invention wherein the condition is a contrast of the image.

In accordance with another aspect of the present invention wherein the condition is a luminance level measured by a luminance meter.

### BRIEF DESCRIPTION OF THE DRAWINGS

The exemplary embodiments will hereinafter be described in conjunction with the following drawing figures, wherein like numerals denote like elements, and wherein:

FIG. 1 shows an application illustrating an exemplary method for enhanced video display according to an exemplary embodiment of the present disclosure;

FIG. 2 shows a block diagram illustrating an exemplary apparatus for enhanced video display according to an exemplary embodiment of the present disclosure; and

FIG. 3 shows a flow chart illustrating an exemplary method for enhanced video display according to an exemplary embodiment of the present disclosure.

FIG. 4 shows a block diagram illustrating another exemplary apparatus for enhanced video display according to an exemplary embodiment of the present disclosure; and

FIG. 5 shows a flow chart illustrating another exemplary method for enhanced video display according to an exemplary embodiment of the present disclosure.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

The present application discloses a system and method to apply different video upscaling, or upconversion, algorithms to improve human vision. In a vehicle application, a camera in a camera system may be used to detect images and video in extreme ranges of conditions. For example, the camera may be used in direct sunlight, complete darkness, snow, rain, and foggy conditions. The camera may be used to capture images with wide ranges of luminance, such as entering a tunnel on a sunny day. The method and system include an algorithm designed to pick between different suitable upscaling techniques to optimize image quality for human vision applications in response to scene content, lighting, and environmental conditions. The method is further operative to adjust the upscaling algorithm in real-time depending on changing scene content and environmental conditions to provide best image quality for the application.

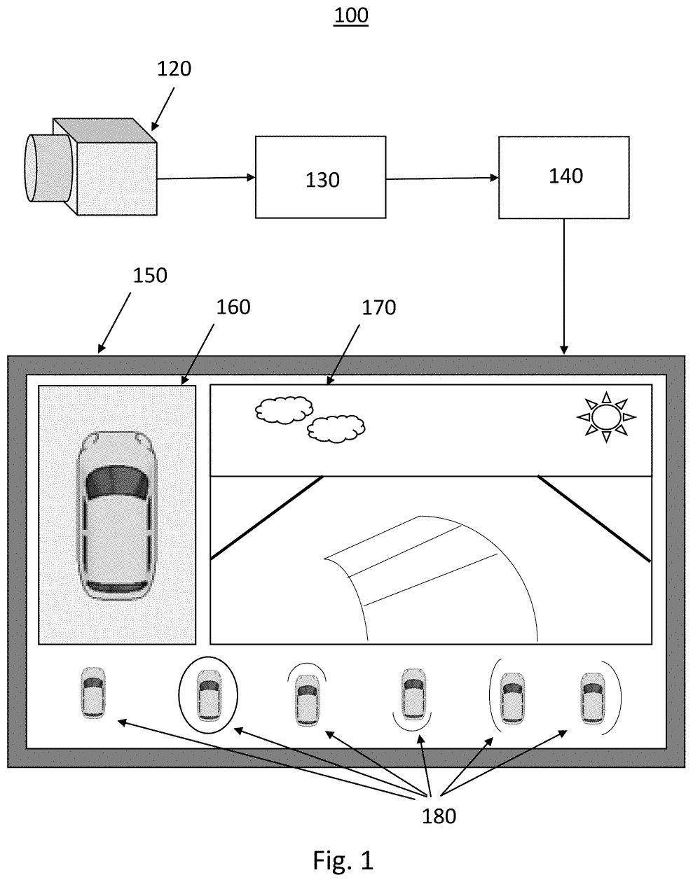

Turning now to FIG. 1, an application for the method and apparatus for enhanced video display 100 according to an exemplary embodiment of the present disclosure is shown. The exemplary application includes at least one camera 120, a video processing module 130, an infotainment module 140 and a display 150. The exemplary display 150 may be located within a vehicle passenger compartment and may be operative to show a first top down image 160 of the vehicle wherein the top down image 160 is stitched together from various images taken in different directions around the vehicle. The exemplary display 150 may further display a selected view 170, such as a rear view. Further, the exemplary display 150 may display a number of user selectable options 180 for changing the selected view 170. The exemplary display 150 may be touch sensitive, wherein the user may touch one of the user selectable options 180 and the selected display 170 may be changed. Alternatively, the user selectable options 180 may be highlighted and selected through use of a user interface, such as a button interface, or the like.

The video processing module 130 is operative to receive image data and/or video data from the camera 120 and to process these images or video into images or video streams for use by the infotainment module 140. The camera 120 data may include lower resolution video, such as 1080 by 640 pixels, or 1280×720 pixels. The video image processing module 130 may be operative to perform image stabilization, image enhancement, video encoding and other image processing functions. The video processing module 130 may also be operative to stitch various images together in order to generate composite image of a virtual view. For example, the video processing module 130 may stitch together a left side view and a rear view to form a virtual view from a left rear corner of the vehicle. The video processing module 130 may further be operative to stitch together a front view, left side view, rear view and right side view in order to generate the first top down image 160.

The infotainment module 140 is operative to receive and process the various images and video streams from the video processing module 130 and for coupling to the display. This processing may include video scaling or conversion from one video resolution to another. In this exemplary embodiment, the infotainment module 140 is operative to upconvert the image and video data into a format compatible with the display 150. For example, the video data from the video processing module 130 may be 1280×720 pixels and the display 150 may be 1920×1080 pixels. The infotainment module 140 is then operative to upconvert the video data from the video processing module 130 to 1920×1080 pixels using various upscaling algorithms. Video upscaling algorithms may include nearest neighbor interpolation, bilinear and bicubic algorithms, Lanczos resampling and Sinc resampling.

The display 150 may be a display mounted in the center console in a passenger compartment of a vehicle. In an exemplary embodiment, the display 150 is an LED display mounted on the dashboard. Alternatively, the display 150 may be integrated into the instrument cluster of the vehicle above the steering wheel. The display 150 may also be a video output for coupling to a portable display or may be a transmission medium for wirelessly transmitting the image or video data to a device. For example, the display 150 may be a radio frequency transmitter for transmitting a video stream to a personal wireless device, such as a smart phone.

Different upscaling algorithms may have different performance results. For example, nearest neighbor interpolation may be most effective for high luminance images, but bicubic may be best for low luminance images. Different upscaling algorithms may result in less noise, increased clarity or resolution, sharper edges, higher contracts, etc. Thus, the infotainment module 140 is operative to choose the best upscaling algorithm in response to image characteristics or in response to sensor data coupled to the infotainment module 140. For example, the infotainment module 140 may detect that the camera 120 is operating at a lower frame rate indicative of low light conditions. In this exemplary embodiment, the infotainment module 140 may choose an upscaling algorithm best suited for low luminance images.

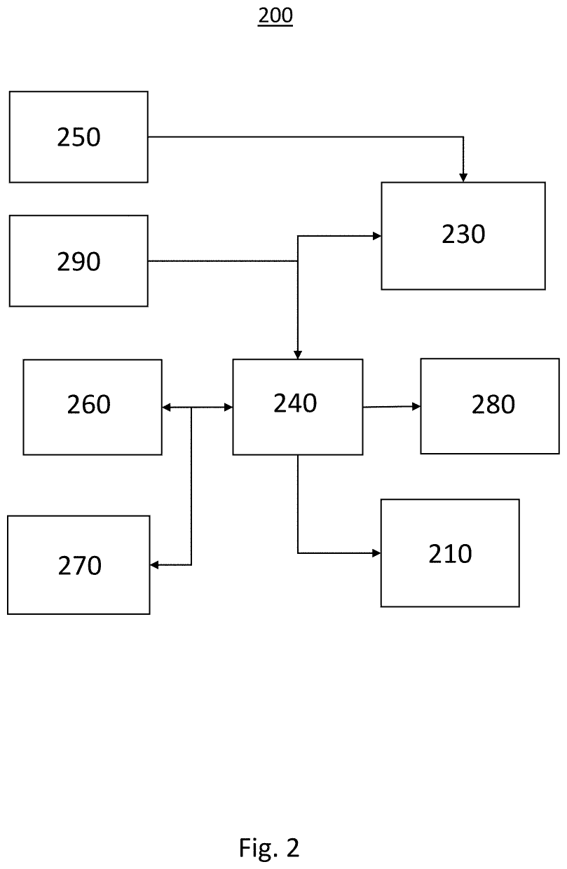

Turning now to FIG. 2, a block diagram of an exemplary system for enhanced video display 200 according to an exemplary embodiment of the present disclosure is shown. The processor 240 is operative to receive sequential image data from the video processing module 230. The processor 240 may then be operative to determine the resolution of the incoming video data and to determine if an upscaling operation is required for display. In selecting the desired upscaling algorithm, the processor 240 may receive data from a sensor 210, such as a light sensor, the processor 240 may determine the frame rate of the incoming video data or receive information on the frame rate from a camera 250. The processor 240 may further receive information from a wireless network receiver 270 indicative of weather conditions, time, geographical location, orientation of the vehicle, environmental information and the like. The processor 240 is then operative to select the most appropriate algorithm in response to one, some, or all of this information.

When starting a video upscaling operation, the processor 240 may determine the most appropriate algorithm in response to a lookup table, or the like, stored on a memory 260. The memory may further be operative to store information, such as computer code, related to the algorithm. This information may be retrieved by the processor 240 in order to perform the upscaling operation. The processor 240 is then operative to perform the upscaling operation to generate an upscaled image and/or video stream and to couple the upscaled image or video stream to a display 280.

In an alternative embodiment, the processor 240 may be operative to determine the upscaling algorithm in response to a use input received via user interface 290. For example, the user may determine that the upscaled video is not satisfactory and select a function that changes the upscaling algorithm. The selection may be made on a rotational basis wherein each selection changes the upscaling algorithm according to a sequential list. Once the end of the list is reached, a further selection returns to the beginning of the list of upscaling algorithms. Alternatively, the user may be presented with a list of upscaling algorithms and may choose the desired algorithms. In this list, the algorithms may or may not be identified by name. In this case, a user may be presented with a list identifying each algorithm with the condition associated with the best performance of each algorithm, such as low light, bright sun, or foggy, etc. The user interface 290 may be integrated into the display 280 as a touch sensitive button, or may be a separate interface.

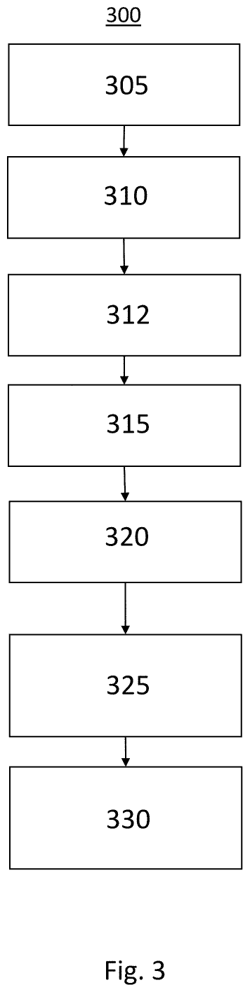

Turning now to FIG. 3, a flow chart illustrating an exemplary method for enhanced video display 300 according to an exemplary embodiment of the present disclosure is shown. In this exemplary embodiment the method performed on an image is described, but the method may be applied to a video stream wherein the video stream comprises a sequence of images. The method may process a single image in a video stream at a time or may processes consecutive images simultaneously or in concert.

The method is first operative to receive image data 305. The image data may be received from a camera, a video processing unit or the like. The image data may be captured by a camera at a frame rate selected in response to lighting and other conditions. For example, the frame rate will be reduced during low light conditions, as a longer time is required to collect enough light to generate the image. Under strong light conditions, a higher frame rate may be used by the camera. The image may also be received from a video processing module. The video processing module may take a number of images and stitch them together to generate a composite image.

The method is then operative to determine the characteristics of the image 310. These characteristics may include resolution, luminance levels, contrast, color, clarity, frame rate, etc. When determining the characteristics of the image 310, the method may determine if an upscaling operation is required. For example, the image received may have a resolution of 1080 by 640 pixels. The image may be intended to be placed in a composition user interface, where the required resolution is 1080 by 640 pixels. Thus, no upscaling operation would be required. In addition, the method may determine that the image does not have the minimum clarity, luminance, or size for an acceptable upscaling operation and may provide a warning to the processor or the user interface.

The method may then be operative to determine the display resolution 312. The display resolution may be retrieved from a memory, may be received from polling the display, or may be a fixed resolution wherein the algorithm is only operative to upscale to a fixed resolution. This may be the case in systems, such as vehicular displays, wherein the display hardware is fixed.

The method may then be operative to receive data from a sensor 315 such as ambient light levels, temperature, weather conditions, time, geographical location, vehicle speed, and vehicle orientation. The method may then determine an upscaling algorithm 320 in response to the image characteristics and the sensor data. For example, the method may determine from the sensor data that there is a low light condition in the image. The method then retrieves the upscaling algorithm with the best performance according to the sensor data.

The method is then operative to upscale the image 325 according to the determined upscaling algorithm to generate an upscaled image. The method is then operative to display the upscaled image 330. The image may be displayed by coupling the image to a display device or transmitting the image to a device operative to display images, such as a mobile device, tablet, monitor or the like.

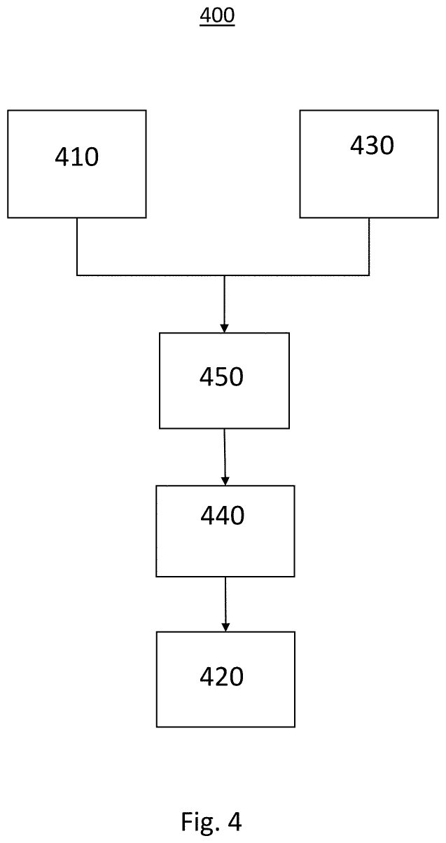

Turning now to FIG. 4, a block diagram of a video system for enhanced video display 400 according to an exemplary embodiment of the present disclosure is shown. The video system 400 includes a camera 410 for capturing an image having a first resolution, a luminance meter 430 for measuring a luminance value, a video controller 440 for determining a third resolution in response to a user input and for generating a user interface at the second resolution in response to the user input and an upscaled image, and a video processor 450 for selecting an upscaling algorithm in response to the first resolution, the third resolution and the luminance value. The video processor 450 is further operative to upscale the image from the first resolution to the third resolution to generate the upscaled image and for coupling the upscaled image to the video controller. The video system 400 may also include a display 420 operative at the second resolution for receiving the user interface from the video controller 440 and for displaying the user interface at the second resolution.

The camera 410 may include a charged coupled device (CCD) or a CMOS device for capturing the image. The device has a spatial resolution defined by a number of sensors within the device, such as 1000×1000 sensors which would capture a 1 megapixel image. The camera 410 may also have an adjustable frame rate, wherein the frame rate is adjusted in response to the amount of light in the image being captures. For example, an image of a bright light scene may be captured at 60 frames per second, wherein low light images may be captured at 30 frames per second. Exposure time is inversely proportional to frame rate.

The luminance meter 430 is a device which detects photometric brightness. In this exemplary embodiment, the luminance meter 430 includes a photoelectric device and detects the amount of light that strikes the surface of a photoelectric device. Luminance is typically measured in lumens and the output of the luminance meter 430 may be indicative of the light level in lumens. Alternatively, the output of the luminance meter 430 may be a voltage that is proportional to the luminance level or may be another indicative data signal. Alternatively, in another exemplary embodiment, the luminance value may be estimated in response to a frame rate of the camera 410.

The video processor 450 is operative to receive the image from the camera 410 and the luminance level from the luminance meter 430. The video processor 450 is also operative to receive an indication of an image resolution from the video controller 440. This image resolution is indicative of the resolution of the image required for display within the user interface on the display 420. For example, the image resolution may be 1920×1080 pixels. The video processor 450 is then operative to determine the resolution of the image from the camera 410. The video processor 450 then uses the resolution of the image, the luminance level and the image resolution from the video controller 440 to select an upscaling algorithm. The video processor 450 is then operative to upscale the image to the image resolution from the video controller 440 and to couple the image to the video controller 440.

In this exemplary embodiment, the video controller 440 is operative to determine the image resolution in response to a user input. The image resolution may be determined in response to the display resolution and the user interface being generated for presentation on the display 420. Alternatively, the display resolution may be determined in response to the resolution of the display device. The video controller 440 is operative to receive the image from the video processor 450, integrate this image into the user interface to generate a user interface image, and to couple user interface image to the display 420. The user interface image is generated at the display resolution. The display 420 may be a touch sensitive display and wherein the display 420 is further operative to receive the user input.

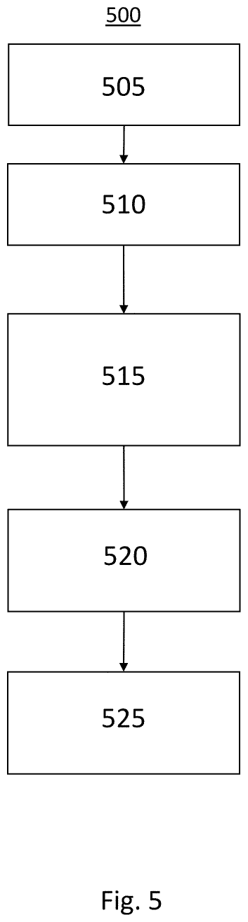

Turning now to FIG. 5, a flow chart illustrating another exemplary method for enhanced video display 500 according to an exemplary embodiment of the present disclosure is shown. A method is first operative to receive an image at a first resolution 505. The image may be received from an onboard vehicle camera, or a video processor operative to compile the image from a plurality of images and data. The received image will have a first resolution. The method is then operative to detect a first environmental condition 510 in response to receive the first image. This environmental condition may include weather data, time and geographical location data, and/or luminance data. In an exemplary embodiment, the luminance data may be determined in response to the light levels in the first image. Alternatively, the luminance level may be determined in response to a camera frame rate or a contrast level of the image. Weather, time and location data may be used to estimate a luminance level and a contrast level of the first image. For example, the weather data may indicate fog in the geographical location and therefore a low contrast may be assumed.

The method is then operative to select an upscaling algorithm 515 in response to the first resolution and the first environmental condition. Upscaling algorithms may include nearest neighbor interpolation, bilinear and bicubic algorithms, Lanczos resampling and Sinc resampling.

In response to the selection of an upscaling algorithm 515, the method then upscales the image according to the upscaling algorithm 520 to generate an upscaled image. This upscaled image is then coupled to the display for display of the upscaled image 525. In this exemplary embodiment, the image resolution may be lower than the upscaled image resolution. For example, the upscaled image resolution is 1920 by 1080 pixels and the image resolution is 1280 by 960 pixels.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A video system comprising:
a camera for capturing an image having a first resolution;
a luminance meter for measuring a luminance value;
a video controller for determining a second resolution in response to a user input and for generating a user interface at the second resolution in response to the user input and an upscaled image;
a processor for selecting an upscaling algorithm in response to the first resolution, the second resolution and the luminance value, the processor further operative to upscale the image from the first resolution to the second resolution to generate the upscaled image and for coupling the upscaled image to the video controller; and
a display for receiving the user interface from the video controller and for displaying the user interface at the second resolution.

2. The video system of claim 1 wherein the luminance value is further determined in response to a camera frame rate.

3. The video system of claim 1 wherein the luminance meter is integrated into the camera.

4. The video system of claim 1 wherein the display is a touch sensitive display and wherein the display is further operative to receive the user input.

5. An apparatus comprising:
a camera for capturing an image having a first resolution;
a display operative at a second resolution;
a sensor for detecting a condition; and
a processor for selecting a scaling algorithm in response to the first resolution, the second resolution and the condition, the processor further operative to scale the image from the first resolution to the second resolution to generate a rescaled image and for coupling the rescaled image to the display.

6. The apparatus of claim 5 wherein the condition is a luminance level.

7. The apparatus of claim 5 wherein the condition is a camera frame rate.

8. The apparatus of claim 5 wherein the condition is a contrast of the image.

9. The apparatus of claim 5 wherein the sensor is a luminance meter.

10. The apparatus of claim 5 wherein the second resolution is higher than the first resolution.

11. The apparatus of claim 5 wherein the second resolution is 1920 by 1080 pixels and the first resolution is 1280 by 960 pixels.

12. The apparatus of claim 5 wherein the first resolution is 1024 by 768 pixels.

13. A method comprising:
capturing, by a camera, an image having a first resolution;
detecting, by a sensor, a condition in response to receiving the image;
selecting, by a processor, an upscaling algorithm in response to the first resolution and the condition;
upscaling, by the processor, the image according to the upscaling algorithm to generate an upscaled image having a second resolution; and
displaying, by a display, the upscaled image.

14. The method of claim 13 wherein the first resolution is lower than the second resolution.

15. The method of claim 13 wherein the second resolution is 1920 by 1080 pixels and the first resolution is 1280 by 960 pixels.

16. The method of claim 13 wherein the first resolution is 1024 by 768 pixels.

17. The method of claim 13 wherein the condition is a luminance level.

18. The method of claim 13 wherein the condition is a camera frame rate.

19. The method of claim 13 wherein the condition is a contrast of the image.

20. The method of claim 13 wherein the condition is a luminance level measured by a luminance meter.
